(19) United States
(12) Patent Application Publication
(10) Pub. No.: US 2021/0221345 A1
(43) Pub. Date: Jul. 22, 2021

(54) Hydraulic Control Apparatus and Brake System

(71) Applicant: Hitachi Automotive Systems, Ltd., Hitachinaka-shi, Ibaraki (JP)

(72) Inventors: Ryohei MARUO, Kawasaki-shi, Kanagawa (JP); Chiharu NAKAZAWA, Kawasaki-shi, Kanagawa (JP)

(21) Appl. No.: 16/305,652

(22) PCT Filed: May 8, 2017
(86) PCT No.: PCT/JP2017/017338

§ 371 Date: Nov. 29, 2018

(30) Foreign Application Priority Data
May 31, 2016 (JP) 2016-108696

(51) Int. Cl. B60T 8/40; B60T 13/14; B60T 13/58

(52) U.S. Cl. CPC B60T 8/409; B60T 13/142; B60T 2270/404; B60T 2270/402; B60T 2270/82; B60T 13/58

(57) ABSTRACT

The present invention provides a hydraulic control apparatus and a brake system capable of preventing or cutting down an increase in a size around a master cylinder. One aspect of the present invention includes a first hydraulic unit, a second hydraulic unit, and a stroke simulator unit. The first hydraulic unit includes a first input port connected to a supply port of a master cylinder, a first connection fluid passage connected to the first input port, a first pump configured to discharge brake fluid to the first connection fluid passage, and a first output port connected to the first connection fluid passage. The second hydraulic unit includes a second input port connected to the first output port, a second connection fluid passage connected to the second input port, a second pump configured to discharge the brake fluid to the second connection fluid passage, and a second output port having one end side connected to the second connection fluid passage and the other end side connected to a wheel cylinder. The stroke simulator unit is attached on the second hydraulic unit and includes a stroke simulator.

### TECHNICAL FIELD

The present invention relates to a hydraulic control apparatus and a brake system.

### BACKGROUND ART

There is known a vehicle brake system including a master cylinder apparatus, a motor cylinder apparatus, and a hydraulic control apparatus (for example, PTL 1).

### CITATION LIST

### Patent Literature

[PTL 1] International Publication No. 2013-147127

### SUMMARY OF INVENTION

### Technical Problem

One of objects of the present invention is to provide a hydraulic control apparatus and a brake system capable of preventing or cutting down an increase in a size around the master cylinder.

### Solution to Problem

In a hydraulic control apparatus according to one aspect of the present invention, a stroke simulator unit is attached on a second hydraulic unit.

Therefore, according to the one aspect of the present invention, the increase in the size around the master cylinder can be prevented or cut down.

### BRIEF DESCRIPTION OF DRAWINGS

FIG. 1 is a perspective view of a brake system BS according to a first embodiment.

FIG. 2 illustrates a schematic configuration of a master cylinder unit 1 according to the first embodiment.

FIG. 3 illustrates schematic configurations of a first hydraulic unit 2 and a second hydraulic unit 3 according to the first embodiment.

FIG. 4 is a perspective view of a brake system BS according to a second embodiment.

### DESCRIPTION OF EMBODIMENTS

### First Embodiment

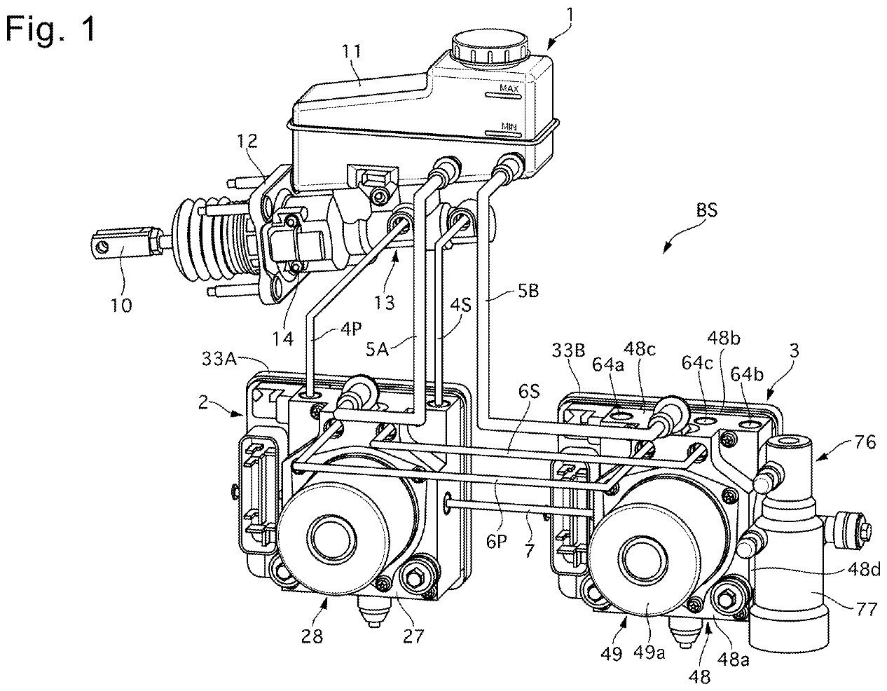

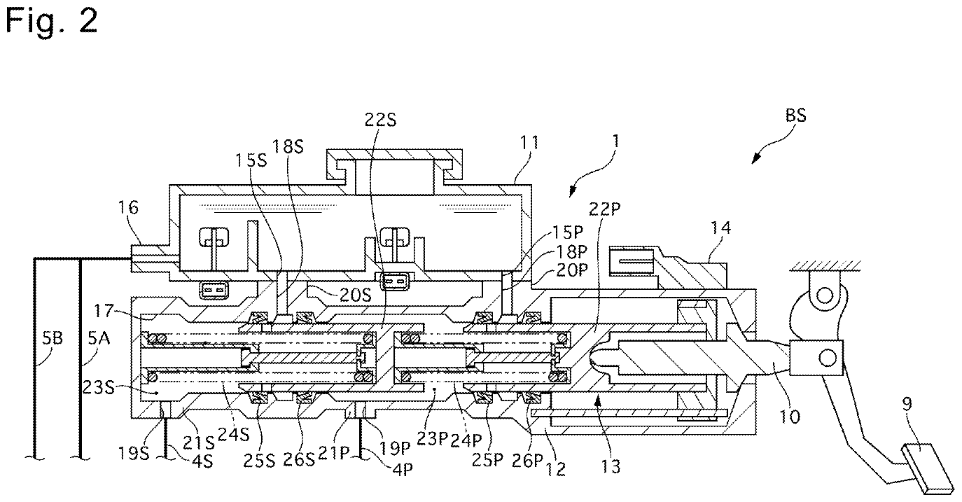

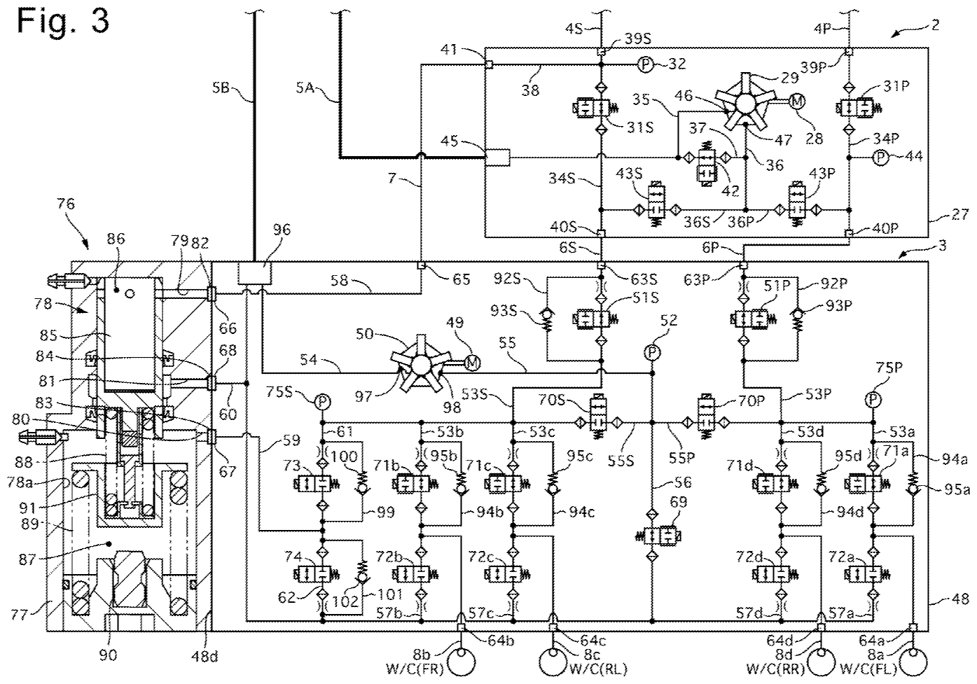

FIG. 1 is a perspective view of a brake system BS according to a first embodiment. FIG. 2 illustrates a schematic configuration of a master cylinder unit 1 according to the first embodiment. FIG. 3 illustrates schematic configurations of a first hydraulic unit 2 and a second hydraulic unit 3 according to the first embodiment. The brake system BS according to the first embodiment is a hydraulic brake system mountable on a hybrid automobile including an electric motor generator in addition to an internal combustion engine, an electric automobile including only the electric motor generator, and the like, besides a vehicle including only the internal combustion engine (an engine) as a prime mover that drives wheels. The brake system BS includes a disk-type brake actuation unit on each of wheels FL to RR (a front left wheel FL, a front right wheel FR, a rear left wheel RL, and a rear right wheel RR). The brake system BS applies a frictional braking force to each of the wheels FL to RR by supplying brake fluid serving as hydraulic fluid to a wheel cylinder W/C of the brake actuation unit and pressing brake pads against a brake disk. The brake system BS includes brake pipes of two systems (a primary P system and a secondary S system). A brake pipe configuration is, for example, an X-split pipe configuration. The brake system BS may employ another pipe configuration, such as a front/rear split pipe configuration. Hereinafter, when a member corresponding to the primary system (the P system) and a member provided corresponding to the secondary system (the S system) are distinguished from each other, they will be distinguished from each other as appropriate by adding indexes P and S at the ends of the reference numerals thereof, respectively. The brake system BS supplies the brake fluid to each of the wheel cylinders W/C via a brake pipe.

The brake system BS includes the master cylinder unit 1, the first hydraulic unit 2, and the second hydraulic unit 3. The first hydraulic unit 2 and the second hydraulic unit 3 are a hydraulic control apparatus that controls a brake hydraulic pressure (a wheel cylinder hydraulic pressure) of each of the wheel cylinders W/C. The master cylinder unit 1 and the first hydraulic unit 2 are connected to each other via a first primary pipe 4P, a first secondary pipe 4S, and a reservoir pipe 5A. The master cylinder unit 1 and the second hydraulic unit 3 are connected to each other via a reservoir pipe 5B. The first hydraulic unit 2 and the second hydraulic unit 3 are connected to each other via a second primary pipe 6P, a second secondary pipe 6S, and a unit connection pipe 7. The second hydraulic unit 3 and each of the wheel cylinders W/C are connected to each other via wheel cylinder pipe 8a, 8b, 8c, or 8d.

The master cylinder unit 1 includes a brake pedal 9, an input rod 10, a reservoir tank 11, a master cylinder housing 12, a master cylinder 13, and a stroke sensor 14. The master cylinder unit 1 does not include a booster that boosts a brake operation force by utilizing, for example, an intake negative pressure generated by an engine. The brake pedal 9 receives an input of a brake operation performed by a driver. The input rod 10 is vertically rotatably connected to the brake pedal 9. The reservoir tank 11 stores therein the brake fluid while keeping it at an atmospheric pressure. The reservoir tank 11 includes replenishment ports 15 and supply ports 16. The reservoir tank 11 includes two supply ports 16. One of the support ports 16 is connected to the reservoir pipe 5A. The other of the support ports 16 is connected to the reservoir pipe 5B. The master cylinder housing 12 is a casing that contains (houses) the master cylinder 13 therein. The master cylinder housing 12 includes therein a cylinder 17 for the master cylinder 13, replenishment fluid passages 18, and supply fluid passages 19. One end side of each of the replenishment fluid passages 18 is connected to the cylinder 17. The other end side of each of the replenishment fluid passages 18 is connected to a replenishment port 20 opened on an outer surface of the master cylinder housing 12. The replenishment port 20 is connected to the replenishment port 15 of the reservoir tank 11. One end side of each of the supply fluid passages 19 is connected to the cylinder 17. The other end side of each of the supply fluid passages 19 is connected to a supply port 21 opened on the outer surface of the master cylinder housing 12. The supply port 21P is connected to the primary pipe 4P. The supply port 21S is connected to the secondary pipe 4S.

The master cylinder 13 is connected to the brake pedal 9 via the input rod 10, and generates a master cylinder hydraulic pressure according to the operation performed by the driver on the brake pedal 9. The master cylinder 13 includes pistons 22 axially movable according to the operation on the brake pedal 9. The pistons 22 are contained inside the cylinder 17, and define hydraulic chambers 23. The master cylinder 13 is a tandem-type cylinder, and includes a primary piston 22P pushed by the input rod 10 and a secondary piston 22S configured as a free piston as the pistons 22. These pistons 22P and 22S are arranged in series. These pistons 22P and 22S define a primary chamber 23P in the cylinder 17. The secondary piston 22S defines a secondary chamber 23S in the cylinder 17. Each of the hydraulic chambers 23P and 23S is replenished with the brake fluid from the reservoir tank 11, and generates the master cylinder hydraulic pressure by a movement of the above-described piston 22. A coil spring 24P as a return spring is disposed in the primary chamber 23P. The coil spring 24P is disposed between these pistons 22P and 22S. A coil spring 24S as a return spring is disposed in the secondary chamber 23S. The coil spring 24S is disposed between a bottom portion of the cylinder 17 and the piston 22S. Piston seals 25 and 26 are set on an inner periphery of the cylinder 17. The piston seals 25 and 26 are a plurality of seal members that seals between an outer peripheral surface of each of the pistons 22P and 22S and an inner peripheral surface of the cylinder 17 while being in sliding constant with each of the pistons 22P and 22S. Each of the piston seals is a known seal member cup-shaped in cross-section that includes a lip portion on an inner diameter side (a cup seal). Each of the piston seals permits a flow of the brake fluid in one direction while prohibiting or reducing a flow of the brake fluid in the other direction with the lip portion in contact with the outer peripheral surface of the piston 22. The first piston seal 25 permits a flow of the brake fluid directed from the replenishment port 15 toward the primary chamber 23P or the secondary chamber 23S while prohibiting or reducing a flow of the brake fluid in an opposite direction. The second piston seal 26 permits a flow of the brake fluid directed toward the replenishment port 15 while prohibiting or reducing an outflow of the brake fluid from the replenishment port 15. The stroke sensor 14 detects a movement amount of the primary piston 22P (a pedal stroke amount).

The first hydraulic unit 2 includes a first hydraulic unit housing 27, a first motor 28, a first pump (a first hydraulic source) 29, a plurality of electromagnetic valves 31 and the like, a plurality of hydraulic sensors 32 and the like, and a first electronic control unit 33A. The first unit housing 27 is a casing that contains (houses) the first pump 29 and valve bodies of the electromagnetic valves 31 and the like therein. As illustrated in FIG. 1, the first hydraulic unit housing 27 is a generally cuboidal metallic block. The first unit housing 27 includes therein circuits of the above-described two systems (the P system and the S system), through which the brake fluid flows. The circuits of the two systems include a plurality of fluid passages. The plurality of fluid passages includes first connection fluid passages 34, a first intake fluid passage 35, a first discharge fluid passage 36, a first return flow fluid passage 37, and a positive pressure fluid passage 38. Further, the first hydraulic unit housing 27 includes a plurality of ports. The plurality of ports includes first input ports 39, first output ports 40, and a positive pressure port 41. The first input port 39P is connected to the first primary pipe 4P. The first input port 39S is connected to the first secondary pipe 4S. The first output port 40P is connected to the second primary pipe 6P. The first output port 40S is connected to the second secondary pipe 6S. The positive pressure port 41 is connected to the unit connection pipe 7. The first pump 29 introduces the brake fluid therein from the reservoir tank 11, and discharges this brake fluid. In the first embodiment, a plunger pump including five plungers, which is excellent in terms of, for example, a noise and vibration performance, is employed as the first pump 29. The first motor 28 drives the first pump 29. The plurality of electromagnetic valves 31 and the like are each a solenoid valve that operates according to a control signal. The plurality of electromagnetic valves 31 and the like each switch opening/closing of the fluid passage (establish or block communication through the fluid passages) due to a stroke of the valve body thereof according to power supply to the solenoid. The plurality of electromagnetic valves 31 and the like each generate a control hydraulic pressure by controlling a communication state of the above-described circuit to adjust a flow state of the brake fluid. The plurality of electromagnetic valves 31 and the like include first shut-off valves 31, a first pressure adjustment valve 42, and first communication valves 43. The first shut-off valves 31 and the first pressure adjustment valve 42 are each a normally opened proportional control valve opened when no power is supplied thereto. The first communication valves 43 are each a normally closed ON/OFF valve closed when no power is supplied thereto. In FIG. 3, the plurality of electromagnetic valves 31 and the like are in the state that no power is supplied thereto. The plurality of hydraulic sensors 32 and the like include a master cylinder hydraulic sensor 32 and a first discharge pressure sensor 44.

Information input to the first electronic control unit 33A includes detection values of the stroke sensor 14 and the plurality of hydraulic sensors 32 and the like, information regarding a running state from the vehicle side, and information from the second hydraulic unit 3. The first electronic control unit 33A controls opening/closing operations of the plurality of electromagnetic valves 31 and the like and the number of rotations of the first motor 28 (i.e., a discharge flow rate of the first pump 29) with use of each of the input detection values and pieces of information based on a program built therein.

In the following description, the brake hydraulic circuit of the first hydraulic unit 2 will be described.

One end sides of the first connection fluid passages 34 are connected to the first input ports 39. The other end sides of the first connection fluid passages 34 are connected to the first output ports 40. The first shut-off valves 31 are disposed in the first connection fluid passages 34. The master cylinder hydraulic sensor 32 is disposed at a position on one side where the first input ports 39 are located with respect to the first shut-off valve 31S of the first connection fluid passage 34S. The master cylinder hydraulic sensor 32 detects the master cylinder hydraulic pressure. The first discharge pressure sensor 44 is disposed at a position on the other side where the first output ports 40 are located with respect to the first shut-off valve 31P of the first connection fluid passage 34P. The first discharge pressure sensor 44 detects the discharge pressure of the first pump 29. One end side of the first intake fluid passage 35 is connected to an internal reservoir tank 45, which is a fluid pool. The internal reservoir tank 45 is connected to the reservoir pipe 5A. The other end side of the first intake fluid passage 35 is connected to a first intake port 46 of the first pump 29. One end side of the discharge fluid passage 36 is connected to a first discharge port 47 of the first pump 29. The other end side of the first discharge fluid passage 36 branches off into a discharge fluid passage 36P of the P system and a discharge fluid passage 36S of the S system. Both the discharge fluid passages 36P and 36S are connected to positions on the other side where the first output ports 40 are located with respect to the first shut-off valves 31 in the first connection fluid passages 34. The first communication valves 43P and 43S are disposed in these discharge fluid passages 36P and 36S, respectively. One end side of the first return flow fluid passage 37 is connected to the first intake fluid passage 35. The other end side of the first return flow fluid passage 37 is connected to the first discharge fluid passage 36. The first pressure adjustment valve 42 is disposed in the first return flow fluid passage 37.

The second hydraulic unit 3 includes a second hydraulic unit housing (a second housing) 48, a second motor 49, a second pump (a second hydraulic source) 50, a plurality of electromagnetic valves 51 and the like, a plurality of hydraulic sensors 52 and the like, and a second electronic control unit (a control unit) 33B. Hereinafter, when a member corresponding to each of the wheels FL to RR is distinguished from one another, they will be distinguished from one another as appropriate by adding indexes a to d at the ends of the reference numerals thereof, respectively. The second hydraulic unit housing 48 is a casing that contains (houses) the second pump 50 and valve bodies of the plurality of electromagnetic valves 51 and the like therein. As illustrated in FIG. 1, the second hydraulic unit housing 48 is a generally cuboidal metallic block. A front surface (a first surface) 48a of the second hydraulic unit housing 48 is a second motor attachment surface where the second motor 49 is attached. A back surface (a second surface) 48b opposite of the second hydraulic unit housing 48 from the front surface 48a is a second electronic control unit attachment surface where the second electronic control unit 33B is attached. The second hydraulic unit housing 48 includes therein circuits of the above-described two systems (the P system and the S system), through which the brake fluid flows. The circuits of the two systems include a plurality of fluid passages. The plurality of fluid passages includes second connection fluid passages 53, a second intake fluid passage 54, second discharge fluid passages 55, a second return flow fluid passage 56, pressure reduction fluid passages 57, a positive pressure fluid passage 58, a back-pressure fluid passage 59, a replenishment fluid passage 60, a first simulator fluid passage 61, and a second simulator fluid passage 62. The positive pressure fluid passage 58, the back-pressure fluid passage 59, and the replenishment fluid passage 60 are unit connection fluid passages. Further, the second hydraulic unit housing 48 includes a plurality of ports. The plurality of ports includes second input ports 63, second output ports 64, a positive pressure port 65, a positive pressure port 66, a back-pressure port 67, and a replenishment port 68. The positive pressure port 66, the back-pressure port 67, and the replenishment port 68 are unit connection ports. The second input port 63P is connected to the second primary pipe 6P. The second input port 63S is connected to the secondary pipe 6S. The second output ports 64 are connected to the wheel cylinders W/C. The second output ports 64 are opened to a top surface (a third surface) 48c of the second hydraulic unit housing 48. The top surface 48c is a surface continuous to the front surface 48a and the back surface 48b. The positive pressure port 65 is connected to the unit connection pipe 7. The positive pressure port 66, the back-pressure port 67, and the replenishment port 68 are opened on a right side surface (a fourth surface) 48d of the second hydraulic unit housing 48. The right side surface 48d is a surface continuous to the front surface 48a, the back surface 48b, and the top surface 48c. The second pump 50 introduces the brake fluid reserved in the reservoir tank 11, and discharges this brake fluid. The second pump 50 is a plunger pump similar to the first pump 29. The second motor 49 drives the second pump 50. As illustrated in FIG. 1, the second motor 49 includes a second motor housing 49a. The second motor housing 49a is integrated with the front surface (the second motor attachment surface) 48a of the second hydraulic unit housing 48 by fastening bolts. The plurality of electromagnetic valves 51 and the like are each a solenoid valve that operates according to a control signal. The plurality of electromagnetic valves 51 and the like each switch opening/closing of the fluid passage due to a stroke of the valve body thereof according to power supply to the solenoid. The plurality of electromagnetic valves 51 and the like each generate a control hydraulic pressure by controlling a communication state of the above-described circuit to adjust a flow state of the brake fluid. The plurality of electromagnetic valves 51 and the like include the second shut-off valves 51, a second pressure adjustment valve 69, second communication valves 70, solenoid IN valves 71, solenoid OUT valves 72, a stroke simulator IN valve 73, and a stroke simulator OUT valve 74. The stroke simulator IN valves 73 and the stroke simulator OUT valves 74 are stroke simulator valves. The second shut-off valves 51, the second pressure adjustment valve 69, and the solenoid IN valves 71 are each a normally opened proportional control valve opened when no power is supplied thereto. The second communication valves 70, the solenoid OUT valves 72, the stroke simulator IN valve 73, and the stroke simulator OUT valve 74 are each a normally closed ON/OFF valve closed when no power is supplied thereto. In FIG. 3, the plurality of electromagnetic valves 51 and the like are in the state that no power is supplied thereto. The plurality of hydraulic sensors 52 and the like include the second discharge pressure sensor 52 and wheel cylinder hydraulic sensors 75.

Information input to the second electronic control unit 33B includes detection values of the stroke sensor 14 and the plurality of hydraulic sensors 52 and the like, information regarding a running state from the vehicle side, and information from the first hydraulic unit 2. The second electronic control unit 33B controls opening/closing operations of the plurality of electromagnetic valves 51 and the like and the number of rotations of the second motor 49 (i.e., a discharge flow rate of the second pump 50) with use of each of the input detection values and pieces of information based on a program built therein.

The stroke simulator unit 76 is attached on the second hydraulic unit 3. The stroke simulator unit 76 is disposed so as to be located closer to one side where the front surface 48a is located than to the other side where the back surface 48b is located. The stroke simulator unit 76 includes a stroke simulator housing 77 and a stroke simulator 78. The stroke simulator housing 77 is a casing that contains (houses) the stroke simulator 78 therein. The stroke simulator housing 77 includes a cylinder 78a and a plurality of simulator connection fluid passages therein. An axial direction of the cylinder 78a extends in a longitudinal direction of the right side surface 48d of the second hydraulic unit housing 48. In other words, the longitudinal direction of the right side surface 48d coincides with a direction of an axis along which the stroke simulator 78 is actuated (an axial direction of the cylinder 78a). The plurality of simulator connection fluid passages includes a positive pressure fluid passage (a first simulator connection fluid passage) 79, a back-pressure fluid passage (a second simulator connection fluid passage) 80, and a replenishment fluid passage 81. Further, the stroke simulator housing 77 includes a plurality of simulator connection ports. The plurality of simulator connection ports includes a positive pressure port 82, a back-pressure port 83, and a replenishment port 84. The stroke simulator 78 includes a piston 85, a positive pressure chamber (a first chamber) 86, a back-pressure chamber (a second chamber) 87, and elastic members (a first spring 88, a second spring 89, and a damper 90). The piston 85, the positive pressure chamber 86, the back-pressure chamber 87, and the elastic members are disposed inside the cylinder 78a. The piston 85 is slidable in the axial direction of the cylinder 78a in the cylinder 78a (the direction of the axis along which the stroke simulator 78 is actuated). The piston 85 divides the inside of the cylinder 78a into the positive pressure chamber 86 and the back-pressure chamber 87. The elastic members bias the piston 85 in a direction for reducing a volume of the positive pressure chamber 86. A bottomed cylindrical retainer member 91 is disposed between the first spring 88 and the second spring 89. The positive pressure chamber 86 is connected to one end side of the positive pressure fluid passage 79. The back-pressure chamber 87 is connected to one end side of the back-pressure fluid passage 80. When the back-pressure chamber 87 has a negative pressure therein, the back-pressure chamber 87 is in communication with one end side of the replenishment fluid passage 81. The other end side of the positive pressure fluid passage 79 is connected to the positive pressure port 82. The positive pressure port 82 is connected to the positive pressure port 66. The positive pressure port 66 and the positive pressure port 82 are in communication with each other by overlapping each other in an axial direction of the positive pressure port 82. As illustrated in FIG. 1, the positive pressure port 82 and the positive pressure port 66 overlap each other on the right side surface 48d of the second hydraulic unit housing 48. The other end side of the back-pressure chamber 80 is connected to the back-pressure port 83. The back-pressure port 83 is connected to the back-pressure port 67. The other end side of the replenishment fluid passage 81 is connected to the replenishment port 84. The replenishment port 84 is connected to the replenishment port 68. In the stroke simulator 78, the piston 85 is moved to the one side in the axial direction of the cylinder 78a (a direction for increasing the volume of the positive pressure chamber 86) when the brake fluid flows from the secondary chamber 23S of the master cylinder 13 into the positive pressure chamber 86 according to the brake operation by the driver. At this time, the elastic members are compressed according to the movement of the piston 85. As a result, the stroke simulator 78 can generate a brake operation reaction force at the same time as generating a pedal stroke according to the brake operation.

In the following description, the brake hydraulic circuit of the second hydraulic unit 3 will be described.

One end sides of the second connection fluid passages 53 are connected to the second input ports 63. The other end side of the second connection fluid passage 53P branches off into the second connection fluid passage 53a and the second connection fluid passage 53d. The other end side of the second connection fluid passage 53S branches off into the second connection fluid passage 53b and the second connection fluid passage 53c. The second connection fluid passages 53a to 53d are connected to the second output ports 64a to 64d, respectively. The second shut-off valve 51 is provided in each of the second connection fluid passages 53. A bypass fluid passage 92 is provided in parallel with the second connection fluid passage 53 while bypassing the second shut-off valve 51. A check valve 93 is provided in the bypass oil passage 92. The check valve 93 permits only a flow of the brake fluid directed from one side where the second input ports 63 are located toward the other side where the second output ports 64 are located. The solenoid IN valve 71a and the solenoid IN valve 71d are provided in the second connection fluid passage 53a and the second connection fluid passage 53d, respectively. A bypass fluid passage 94a and a bypass fluid passage 94d are provided in parallel with the second connection fluid passage 53a and the second connection fluid passage 53d while bypassing the solenoid IN valve 71a and the solenoid IN valve 71d, respectively. A check valve 95a and a check valve 95d are provided in the bypass fluid passage 94a and the bypass fluid passage 94d, respectively. The check valve 95a and the check valve 95d permit only a flow of the brake fluid directed from the other side where the second output ports 64 are located toward the one side where the second input ports 63 are located. The solenoid IN valve 71b and the solenoid IN valve 71c are provided in the second connection fluid passage 53b and the second connection fluid passage 53c, respectively. A bypass fluid passage 94b and a bypass fluid passage 94c are provided in parallel with the second connection fluid passage 53b and the second connection fluid passage 53c while bypassing the solenoid IN valve 71b and the solenoid IN valve 71c, respectively. A check valve 95b and a check valve 95c are provided in the bypass fluid passage 94b and the bypass fluid passage 94c, respectively. The check valve 95b and the check valve 95c permit only a flow of the brake fluid directed from the other side where the second output ports 64 are located toward the one side where the second input ports 63 are located.

One end side of the second intake fluid passage 54 is connected to an internal reservoir tank 96, which is a fluid pool. The other end side of the second intake fluid passage 54 is connected to a second intake port 97 of the second pump 50. One end side of the second discharge fluid passage 55 is connected to a second discharge port 98 of the second pump 50. The second discharge pressure sensor 52 is provided in the second discharge fluid passage 55. The second discharge pressure sensor 52 detects a discharge pressure of the second pump 50. The other end side of the second discharge fluid passage 55 branches off into a discharge fluid passage 55P of the P system and a discharge fluid passage 55S of the S system. Both the discharge fluid passages 55P and 55S are connected to positions on the other side where the second output ports 64 are located with respect to the second shut-off valves 51 of the second connection fluid passages 53. The second communication valves 70P and 70S are provided in these discharge fluid passages 55P and 55S, respectively. One end side of the second return flow fluid passage 56 is connected to a position at which the second discharge fluid passage 55 and both the discharge fluid passages 55P and 55S are connected to each other. The other end side of the second return flow fluid passage 56 is connected to the internal reservoir tank 96. A second pressure adjustment valve 69 is provided in the second return flow fluid passage 56. One end side of each of the pressure reduction fluid passages 57 is connected to a position on the other side where the second output ports 64 are located with respect to the solenoid IN valves 71 of the second connection fluid passages 53. The other end side of each of the pressure reduction fluid passages 57 is connected to the second return flow fluid passage 56. The solenoid OUT valves 72 are provided in the pressure reduction fluid passages 57. One end side of the positive pressure fluid passage 58 is connected to the positive pressure port 65. The other end side of the positive pressure fluid passage 58 is connected to the positive pressure port 66. The back-pressure fluid passage 59 is connected to the back-pressure port 67. One end side of the replenishment fluid passage 60 is connected to the replenishment port 68. The other end side of the replenishment fluid passage 60 is connected to the second return flow fluid passage 56. One end side of the first simulator fluid passage 61 is connected to the back-pressure fluid passage 59. The other end side of the first simulator fluid passage 61 is connected to a position on the other side where the second output ports 64 are located with respect to the second shut-off valve 51S of the second connection fluid passage 53S, and on the one side where the second input ports 63S are located with respect to the solenoid IN valves 71b and 71c. The stroke simulator IN valve 73 is provided in the first simulator fluid passage 61. A bypass fluid passage 99 is provided in parallel with the first simulator fluid passage 61 while bypassing the stroke simulator valve IN 73. A check valve 100 is provided in the bypass fluid passage 99. The check valve 100 permits only a flow of the brake fluid directed from one side where the back-pressure fluid passage 59 is located toward the other side where the second connection fluid passage 53S is located. One end side of the second simulator fluid passage 62 is connected to the back-pressure fluid passage 59. The other end side of the second simulator fluid passage 62 is connected to the second return flow fluid passage 56. The stroke simulator OUT valve 74 is provided in the second simulator fluid passage 62. A bypass oil passage 101 is provided in parallel with the second simulator fluid passage 62 while bypassing the stroke simulator OUT valve 74. A check valve 102 is provided in the bypass fluid passage 101. The check valve 102 permits only a flow of the brake fluid directed from the other side where the second return flow fluid passage 56 is located toward the one side where the back-pressure fluid passage 59 is located.

Next, an operation of the brake system BS will be described.

First, the operation of the brake system BS will be described focusing on an operation thereof at the time of normal braking that generates a vehicle deceleration according to the brake operation performed by the driver. The master cylinder unit 1 according to the first embodiment does not include a booster that boosts the brake operation force input by the driver. Therefore, the brake system BS performs the following boosting control at the time of the normal braking.

The first electronic control unit 33A controls the first shut-off valves 31 in valve-closing directions, thereby shutting off the flow of the brake fluid between the master cylinder 13 and the first hydraulic unit 2.

The second electronic control unit 33B controls the second communication valves 70 in valve-opening directions, thereby establishing the communication between the second connection fluid passage 53P of the P system and the second connection fluid passage 53S of the S system. Further, the second electric control unit 33B controls the stroke simulator OUT valve 74 in a valve-opening direction, thereby causing the stroke simulator 78 to function. The second electric control unit 33B calculates a target wheel cylinder hydraulic pressure for acquiring a predetermined boosting ratio based on a pedal stroke amount detected by the stroke sensor 14, and calculates a target upstream hydraulic pressure for realizing the target wheel cylinder hydraulic pressure. The second electric control unit 33B causes the second pump 50 to operate at a predetermined number of rotations, and controls the second pressure adjustment valve 69 in a valve-closing direction in such a manner that an upstream hydraulic pressure of the second pressure adjustment valve 69 detected by the first discharge pressure sensor 44 matches the target upstream hydraulic pressure.

By this operation, the brake system BS can acquire a vehicle deceleration according to a driver's request while reducing a required brake operation force of the driver.

At the time of sudden braking in which a change amount of the pedal stroke per unit time reaches or exceeds a predetermined sudden braking threshold value, the second electric control unit 33B controls the stroke simulator IN valves 73 in valve-opening directions and controls the stroke simulator OUT valve 74 in a valve-closing direction. By this control, the brake system BS can secure responsiveness for increasing the wheel cylinder hydraulic pressures with use of the brake fluid flowing out of the back-pressure chamber 87 of the stroke simulator 78 since the driver starts the brake operation until the second pump 50 is ready to generate sufficiently high wheel cylinder hydraulic pressures. When the change amount of the pedal stroke per unit time falls below the sudden braking threshold value, the second electric control unit 33B controls the stroke simulator IN valves 73 in valve-closing directions and controls the stroke simulator OUT valve 74 in a valve-opening direction. In other words, the second hydraulic unit 3 returns to the operation at the time of the normal braking.

Next, the operation of the brake system BS will be described focusing on an operation thereof at the time of autonomous application of emergency braking (AEB: Autonomous Emergency Braking). When the brake system BS detects an obstacle present in a direction in which this vehicle is traveling and the vehicle approaches this obstacle, the brake system BS performs the following autonomous emergency braking, thereby suddenly slowing down the vehicle.

The first electronic control unit 33A controls the first shut-off valves 31 in the valve-closing directions and controls the first communication valves 43 in valve-opening directions, thereby establishing the communication between the first connection fluid passage 34P of the P system and the first connection fluid passage 34S of the S system. The first electric control unit 33A causes the first pump 29 to operate at a predetermined number of rotations (for example, a maximum number of rotations), and controls the first pressure adjustment valve 42 in a valve-closing direction in such the manner that an upstream hydraulic pressure of the first pressure adjustment valve 42 detected by the first discharge pressure sensor 44 matches the target upstream hydraulic pressure calculated by the second electronic control unit 33B.

The second electronic control unit 33B controls the second communication valves 70 in valve-opening directions and controls the stroke simulator OUT valve 74 in the valve-opening direction, and causes the second pump 50 to operate at a predetermined number of rotations. The second electronic control unit 33B calculates a target wheel cylinder hydraulic pressure for avoiding a contact with the obstacle or reducing damage from the contact, and calculates a target upstream hydraulic pressure for realizing the target wheel cylinder hydraulic pressure. The second electronic control unit 33B causes the second pump 50 to operate at a predetermined number of rotations (for example, a maximum number of rotations), and controls the second pressure adjustment valve 69 in a valve-closing direction in such a manner that an upstream hydraulic pressure of the second pressure adjustment valve 69 detected by the second discharge pressure sensor 52 matches the target upstream hydraulic pressure.

In the autonomous emergency braking, the brake system BS should generate a larger braking force than the braking force at the time of the normal braking in a short time. Therefore, the pressures in the wheel cylinders W/C should be increased with high responsiveness. In the autonomous emergency braking control according to the first embodiment, the brake system BS actuates both the first pump 29 and the second pump 50 to increase the pressures in the wheel cylinders W/C, thereby succeeding in securing the responsiveness for increasing the pressures in the wheel cylinders W/C that is required for the autonomous emergency braking. The operation of the autonomous emergency braking may be performed at the time of the sudden braking. Further, the brake system BS may increase the wheel cylinder hydraulic pressures in a further short time with use of the brake fluid flowing out of the back-pressure chamber 87 of the stroke simulator 78 by controlling the stroke simulator IN valve 73 in the valve-opening direction and controlling the stroke simulator OUT valve 74 in the valve-closing direction, when the driver performs the brake operation at an initial stage of the autonomous emergency braking control.

Next, functions and effects will be described.

Brake systems with the stroke simulator unit attached on the master cylinder unit involve such a problem that a size around the master cylinder increases and thus vehicle mountability is deteriorated. On the other hand, in the brake system BS according to the first embodiment, the stroke simulator unit 76 is attached on the second hydraulic unit 3. The stroke simulator unit 76 is prepared as a different unit from the master cylinder unit 1 and is disposed at the most downstream second hydraulic unit 3, which can contribute to preventing or cutting down the increase in the size around the master cylinder and also improving safety regarding collision.

The brake system BS increases the wheel cylinder hydraulic pressures with use of the brake fluid flowing out of the back-pressure chamber 87 of the stroke simulator 78 at the time of the sudden braking. In the first embodiment, the stroke simulator unit 76 is attached on the second hydraulic unit 3, which allows the brake system BS to have a shorter length of the fluid passage from the back-pressure chamber 87 to the wheel cylinders W/C compared to when the stroke simulator unit 76 is attached on the master cylinder unit 1 or the first hydraulic unit 2. As a result, the brake system BS can improve the responsiveness for increasing the pressures in the wheel cylinders W/C at the time of the sudden braking.

The second hydraulic unit 3 includes the unit connection ports (the positive pressure port 66, the back-pressure port 67, and the replenishment port 68) connected to the three simulator connection ports (the positive pressure port 82, the back-pressure port 83, and the replenishment port 84) of the stroke simulator unit 76 and overlapping the simulator connection ports in the axial directions of the simulator connection ports, and the unit connection fluid passages (the positive pressure fluid passage 58, the back-pressure fluid passage 59, and the replenishment fluid passage 60) connected to the unit connection ports. In other words, the simulator connection fluid passages (the positive pressure fluid passage 79, the back-pressure fluid passage 80, and the replenishment fluid passage 81) and the unit connection fluid passages are connected to each other by directly attaching the stroke simulator unit 76 on the second hydraulic unit 3. Therefore, the brake system BS does not require a plurality of pipes connecting the simulator connection ports and the unit connection ports, thereby achieving a reduction in a size of the second hydraulic unit 3.

Further, the simulator connection ports and the unit connection ports overlap each other on the right side surface 48d of the second hydraulic unit housing 48. The second motor 49, the second electronic control unit 33B, and the second output ports 64 are not provided on the right side surface 48d, so that the brake system BS can reduce the size of the second hydraulic unit 3 and also improve layout flexibility due to the attachment of the stroke simulator unit 76 to the right side surface 48d, which is the side surface of the motor attachment surface (the front surface 48a) and the second electronic control unit attachment surface (the back surface 48b) and does not have the second output ports 64 opened thereon.

The direction of the axis along which the stroke simulator 78 is actuated is set to a longitudinal direction of the right side surface 48d of the second hydraulic unit 3. As a result, the brake system BS can reduce a projection area (a top surface projection area) when the second hydraulic unit 3 is viewed from a top side where the top surface 48c is located compared to when the direction of the axis along which the stroke simulator 78 is actuated is disposed along a lateral direction of the right side surface 48d, thereby improving the vehicle mountability.

Further, the stroke simulator 78 is disposed closer to the one side where the front surface 48a is located than to the other side where the back surface 48b is located. By this configuration, the brake system BS can effectively utilize a dead space around the second motor housing 49a, thereby reducing the size of the second hydraulic unit 3.

### Second Embodiment

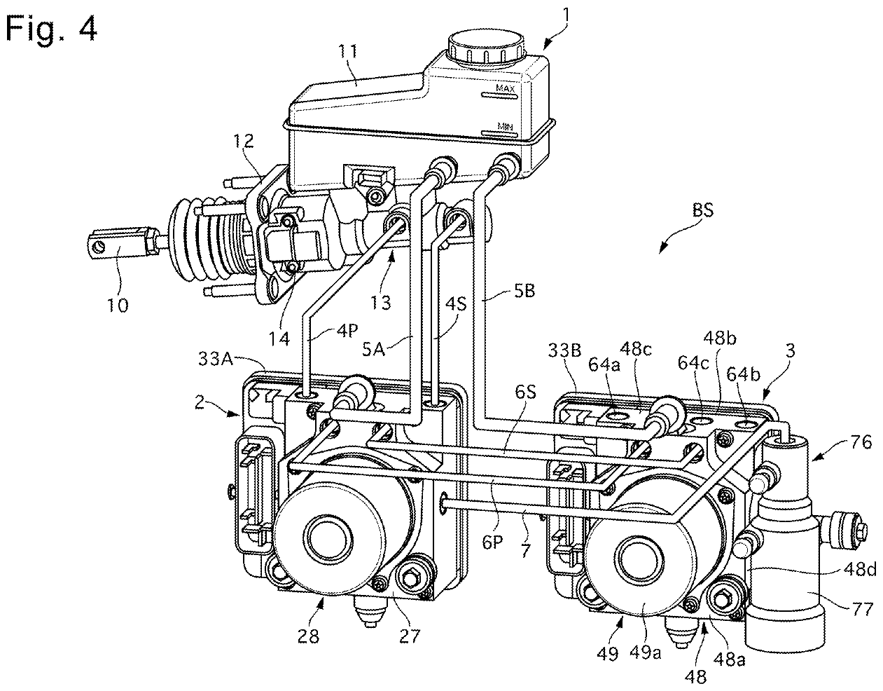

Next, a second embodiment will be described. FIG. 4 is a perspective view of a brake system BS according to the second embodiment. The brake system BS according to the second embodiment is different from the first embodiment in terms of the unit connection pipe (the positive pressure pipe) 7 having one end side connected to the positive pressure port 82 of the stroke simulator unit 76. The other end side of the unit connection pipe 7 is connected to the positive pressure port 41 of the first hydraulic unit housing 27 similarly to the first embodiment. The one end side of the unit connection pipe 7 is connected to the positive pressure port 82, which allows the brake system BS to omit the internal fluid passage (the positive pressure fluid passage 58 illustrated in FIG. 3) of the second hydraulic unit housing 48, thereby achieving the reduction in the size of the second hydraulic unit 3.

### Other Embodiments

Having described the embodiments for implementing the present invention, the specific configuration of the present invention is not limited to the configuration of the embodiments, and the present invention also includes a design modification and the like thereof made within a range that does not depart from the spirit of the present invention, if any.

For example, the one end side and the other end side of the unit connection pipe (the positive pressure pipe) 7 may be connected to the positive pressure port 82 of the stroke simulator unit 76 and the hydraulic chamber 23 of the master cylinder 13, respectively. By this modification, the brake system BS can omit the internal fluid passages (the positive pressure fluid passage 38 and the positive pressure fluid passage 58 illustrated in FIG. 3) of the first hydraulic unit housing 27 and the second hydraulic unit housing 48, thereby achieving reductions in the sizes of the first hydraulic unit 2 and the second hydraulic unit 3.

In the following description, technical ideas recognizable from the above-described embodiments will be described.

A hydraulic control apparatus, in one configuration thereof, includes a first hydraulic unit, a second hydraulic unit, and a stroke simulator unit. The first hydraulic unit includes a first input port connected to a supply port of a master cylinder, a first connection fluid passage connected to the first input port, a first hydraulic source configured to discharge brake fluid to the first connection fluid passage, and a first output port connected to the first connection fluid passage. The second hydraulic unit includes a second input port connected to the first output port, a second connection fluid passage connected to the second input port, a second hydraulic source configured to discharge the brake fluid to the second connection fluid passage, and a second output port having one end side connected to the second connection fluid passage and the other end side connected to a wheel cylinder. The stroke simulator unit is attached on the second hydraulic unit, and includes a stroke simulator configured to generate a reaction force of a brake pedal operation.

According to a further preferable configuration, in the above-described configuration, the second hydraulic unit includes a back-pressure fluid passage connected to a back-pressure chamber of the stroke simulator, a first simulator fluid passage connecting the back-pressure fluid passage and the second connection fluid passage to each other, a second simulator fluid passage connecting the back-pressure fluid passage and an intake side of the second hydraulic source to each other, and a stroke simulator valve configured to selectively switch a connection between the first simulator fluid passage and the second connection fluid passage and a connection between the second simulator fluid passage and the intake side of the second hydraulic source.

According to another preferable configuration, in any of the above-described configurations, the stroke simulator unit includes a simulator connection fluid passage having one end side connected to the stroke simulator, and a simulator connection port provided on the other end side of the simulator connection fluid passage. The second hydraulic unit includes a unit connection port connected to the simulator connection port and overlapping the simulator connection port in an axial direction of the simulator connection port, and a unit connection fluid passage connected to the unit connection port.

According to further another preferable configuration, the stroke simulator unit includes a positive pressure fluid passage connected to a positive pressure chamber of the stroke simulator. The second hydraulic unit includes a second housing having the second connection fluid passage therein. The second hydraulic unit further includes a positive pressure pipe located outside the second housing and connecting the positive pressure fluid passage and the first connection fluid passage or a hydraulic chamber of the master cylinder to each other.

According to further another preferable configuration, in any of the above-described configurations, the stroke simulator includes a piston defining a first chamber and a second chamber in a cylinder. The simulator connection fluid passage includes a first simulator connection fluid passage having the one end side connected to a first chamber, and a second simulator connection fluid passage having the one end side connected to a second chamber.

According to further another preferable configuration, in any of the above-described configurations, the second hydraulic unit includes a second housing including the second connection fluid passage therein, and a second motor attached on a second motor attachment surface of the second housing and configured to actuate the second hydraulic source. The simulator connection port and the unit connection port overlap each other on a side surface of the second motor attachment surface.

According to further another preferable configuration, in any of the above-described configurations, a direction of an axis along which the stroke simulator is actuated is set to a longitudinal direction of the side surface.

According to further another preferable configuration, in any of the above-described configurations, the second hydraulic unit includes a second housing including the second connection fluid passage therein, and a second motor attached on the second housing and configured to actuate the second hydraulic source. The second housing includes a first surface on which the second motor is attached, a second surface located opposite of the second housing from the first surface and configured in such a manner that a control unit for driving the second hydraulic source is disposed thereon, a third surface provided continuously to the first surface and the second surface and configured in such a manner that the second output port is disposed thereon, and a fourth surface provided continuously to the first surface, the second surface, and the third surface, and configured in such a manner that the unit connection port is disposed thereon.

According to further another preferable configuration, in any of the above-described configurations, the stroke simulator is disposed closer to one side where the first surface is located than to the other side where the second surface is located.

According to further another preferable configuration, in any of the above-described configurations, the second hydraulic unit includes a second housing including the second connection fluid passage therein, and a second motor attached on a second motor attachment surface of the second housing and configured to actuate the second hydraulic source. A direction of an axis along which the stroke simulator is actuated is set to a longitudinal direction of a side surface of the second motor attachment surface.

According to further another preferable configuration, in any of the above-described configurations, the simulator connection port and the unit connection port overlap each other on the side surface.

Further, from another aspect, a hydraulic control apparatus includes a first hydraulic unit and a second hydraulic unit. The first hydraulic unit includes a first input port connected to a supply port of a master cylinder, a first connection fluid passage connected to the first input port, a first hydraulic source configured to discharge brake fluid to the first connection fluid passage, and a first output port connected to the first connection fluid passage. The second hydraulic unit includes a second input port connected to the first output port, a second connection fluid passage connected to the second input port, a second hydraulic source configured to discharge the brake fluid to the second connection fluid passage, a second output port having one end side connected to the second connection fluid passage and the other end side connected to a wheel cylinder, and a stroke simulator connected to a supply port of the master cylinder and configured to generate a reaction force of a brake pedal operation.

Preferably, in the above-described configuration, the second hydraulic unit includes a back-pressure fluid passage connected to a back-pressure chamber of the stroke simulator, a first simulator fluid passage connecting the back-pressure fluid passage and the second connection fluid passage to each other, a second simulator fluid passage connecting the back-pressure fluid passage and an intake side of the second hydraulic source to each other, and a stroke simulator valve configured to selectively switch a connection between the first simulator fluid passage and the second connection fluid passage and a connection between the second simulator fluid passage and the intake side of the second hydraulic source.

Further, from another aspect, a brake system includes a first hydraulic unit, a second hydraulic unit, and a stroke simulator unit. The first hydraulic unit includes a master cylinder unit including a master cylinder, a first input port connected to a supply port of the master cylinder, a first connection fluid passage connected to the first input port, a first hydraulic source configured to discharge the brake fluid to the first connection fluid passage, and a first output port connected to the first connection fluid passage The second hydraulic unit includes a second input port connected to the first output port, a second connection fluid passage connected to the second input port, a second hydraulic source configured to discharge the brake fluid to the second connection fluid passage, and a second output port having one end side connected to the second connection fluid passage and the other end side connected to a wheel cylinder. The stroke simulator unit is attached on the second hydraulic unit and includes a stroke simulator configured to generate a reaction force of a brake pedal operation.

Preferably, in the above-described configuration, the second hydraulic unit includes a back-pressure fluid passage connected to a back-pressure chamber of the stroke simulator, a first simulator fluid passage connecting the back-pressure fluid passage and the second connection fluid passage to each other, a second simulator fluid passage connecting the back-pressure fluid passage and an intake side of the second hydraulic source to each other, and a stroke simulator valve configured to selectively switch a connection between the first simulator fluid passage and the second connection fluid passage and a connection between the second simulator fluid passage and the intake side of the second hydraulic source.

According to another preferable configuration, in any of the above-described configurations, the stroke simulator unit includes a simulator connection fluid passage having one end side connected to the stroke simulator, and a simulator connection port provided on the other end side of the simulator connection fluid passage. The second hydraulic unit includes a unit connection port connected to the simulator connection port and overlapping the simulator connection port in an axial direction of the simulator connection port, and a unit connection fluid passage connected to the unit connection port.

According to further another preferable configuration, in any of the above-described configurations, the stroke simulator includes a piston defining a first chamber and a second chamber in a cylinder. The simulator connection fluid passage includes a first simulator connection fluid passage having the one end side connected to the first chamber, and a second simulator connection fluid passage having the one end side connected to the second chamber.

According to further another preferable configuration, in any of the above-described configurations, the second hydraulic unit includes a second housing including the second connection fluid passage therein, and a second motor attached on a second motor attachment surface of the second housing and configured to actuate the second hydraulic source. The simulator connection port and the unit connection port overlap each other on a side surface of the second motor attachment surface.

According to further another preferable configuration, in any of the above-described configurations, a direction of an axis along which the stroke simulator is actuated is set to a longitudinal direction of the side surface.

According to further another preferable configuration, in any of the above-described configurations, the second hydraulic unit includes a second housing including the second connection fluid passage therein, and a second motor attached on a second motor attachment surface of the second housing and configured to actuate the second hydraulic source. A direction of an axis along which the stroke simulator is actuated is set to a longitudinal direction of a side surface of the second motor attachment surface.

According to further another preferable configuration, in any of the above-described configurations, the simulator connection port and the unit connection port overlap each other on the side surface.

Having described merely several embodiments of the present invention, it is apparent to those skilled in the art that the embodiments described as the examples can be modified or improved in various manners without substantially departing from the novel teachings and advantages of the present invention. Therefore, such a modified or improved embodiment is intended to be also contained in the technical scope of the present invention. The features of the above-described embodiments may also be arbitrarily combined.

The present application claims priority under the Paris Convention to Japanese Patent Application No. 2016-108696 filed on May 31, 2016. The entire disclosure of Japanese Patent Application No. 2016-108696 filed on May 31, 2016 including the specification, the claims, the drawings, and the abstract is incorporated herein by reference in its entirety.

### REFERENCE SIGNS LIST

BS brake system

FL to RR wheel

W/C wheel cylinder

1 master cylinder unit

2 first hydraulic unit

3 second hydraulic unit

9 brake pedal

13 master cylinder

21 supply port

29 first pump (first hydraulic source)

34 first connection fluid passage

39 first input port

40 first output port

50 second pump (second hydraulic source)

53 second connection fluid passage

63 second input port

64 second output port

76 stroke simulator unit

78 stroke simulator

1. A hydraulic control apparatus comprising:
a first hydraulic unit; and
a second hydraulic unit,
wherein the first hydraulic unit includes
a first input port connected to a supply port of a master cylinder,
a first connection fluid passage connected to the first input port,
a first hydraulic source configured to discharge brake fluid to the first connection fluid passage, and
a first output port connected to the first connection fluid passage,
wherein the second hydraulic unit includes
a second input port connected to the first output port,
a second connection fluid passage connected to the second input port,
a second hydraulic source configured to discharge the brake fluid to the second connection fluid passage, and
a second output port having one end side and an opposite end side, the one end side being connected to the second connection fluid passage, the opposite end side being connected to a wheel cylinder, and
wherein the hydraulic control apparatus further includes a stroke simulator unit, and the stroke simulator unit is attached on the second hydraulic unit and includes a stroke simulator configured to generate a reaction force of a brake pedal operation.

2. The hydraulic control apparatus according to claim 1, wherein the second hydraulic unit includes
a back-pressure fluid passage connected to a back-pressure chamber of the stroke simulator,
a first simulator fluid passage that connects the back-pressure fluid passage and the second connection fluid passage to each other,
a second simulator fluid passage that connects the back-pressure fluid passage and an intake side of the second hydraulic source to each other, and
a stroke simulator valve configured to selectively switch a connection between the first simulator fluid passage and the second connection fluid passage, and a connection between the second simulator fluid passage and the intake side of the second hydraulic source.

3. The hydraulic control apparatus according to claim 1, wherein the stroke simulator unit includes
a simulator connection fluid passage having one end side connected to the stroke simulator, and
a simulator connection port provided on the other end side of the simulator connection fluid passage, and
wherein the second hydraulic unit includes
a unit connection port connected to the simulator connection port and overlapping the simulator connection port in an axial direction of the simulator connection port, and
a unit connection fluid passage connected to the unit connection port.

4. The hydraulic control apparatus according to claim 1, wherein the stroke simulator unit includes a positive pressure fluid passage connected to a positive pressure chamber of the stroke simulator,
wherein the second hydraulic unit includes a second housing having the second connection fluid passage inside the second hydraulic unit,
wherein the second hydraulic unit further includes a positive pressure pipe, and
wherein the positive pressure pipe is located outside the second housing, and connects the positive pressure fluid passage and the first connection fluid passage or a hydraulic chamber of the master cylinder.

5. The hydraulic control apparatus according to claim 3, wherein the stroke simulator includes a piston defining a first chamber and a second chamber in a cylinder,
wherein the simulator connection fluid passage includes
a first simulator connection fluid passage having the one end side connected to a first chamber, and
a second simulator connection fluid passage having the one end side connected to a second chamber.

6. The hydraulic control apparatus according to claim 5, wherein the second hydraulic unit includes
a second housing including the second connection fluid passage inside this second hydraulic unit, and
a second motor attached on a second motor attachment surface of the second housing and configured to actuate the second hydraulic source, and
wherein the simulator connection port and the unit connection port overlap each other on a side surface of the second motor attachment surface.

7. The hydraulic control apparatus according to claim 6, wherein a direction of an axis along which the stroke simulator is actuated is set to a longitudinal direction of the side surface.

8. The hydraulic control apparatus according to claim 3, wherein the second hydraulic unit includes
a second housing including the second connection fluid passage inside this second hydraulic unit, and
a second motor attached on the second housing and configured to actuate the second hydraulic source, and
wherein the second housing includes
a first surface on which the second motor is attached,
a second surface located opposite of the second housing from the first surface and configured in such a manner that a control unit for driving the second hydraulic source is disposed on the second surface,
a third surface provided continuously to the first surface and the second surface and configured in such a manner that the second output port is disposed on the third surface, and
a fourth surface provided continuously to the first surface, the second surface, and the third surface, and configured in such a manner that the unit connection port is disposed on the fourth surface.

9. The hydraulic control apparatus according to claim 8,
wherein the stroke simulator is disposed closer to one side where the first surface is located than to the other side where the second surface is located.

10. The hydraulic control apparatus according to claim 1, wherein the second hydraulic unit includes
a second housing including the second connection fluid passage inside this second hydraulic unit, and
a second motor attached on a second motor attachment surface of the second housing and configured to actuate the second hydraulic source, and
wherein a direction of an axis along which the stroke simulator is actuated is set to a longitudinal direction of a side surface of the second motor attachment surface.

11. The hydraulic control apparatus according to claim 10, wherein the simulator connection port and the unit connection port overlap each other on the side surface.

12. A hydraulic control apparatus comprising:
a first hydraulic unit; and
a second hydraulic unit,
wherein the first hydraulic unit includes
a first input port connected to a supply port of a master cylinder,
a first connection fluid passage connected to the first input port,
a first hydraulic source configured to discharge brake fluid to the first connection fluid passage, and
a first output port connected to the first connection fluid passage,
wherein the second hydraulic unit includes
a second input port connected to the first output port,
a second connection fluid passage connected to the second input port,
a second hydraulic source configured to discharge the brake fluid to the second connection fluid passage,
a second output port having one end side connected to the second connection fluid passage and an opposite end side connected to a wheel cylinder, and
a stroke simulator connected to a supply port of the master cylinder and configured to generate a reaction force of a brake pedal operation.

13. The hydraulic control apparatus according to claim 12, wherein the second hydraulic unit includes
a back-pressure fluid passage connected to a back-pressure chamber of the stroke simulator,
a first simulator fluid passage that connects the back-pressure fluid passage and the second connection fluid passage,
a second simulator fluid passage that connects the back-pressure fluid passage and an intake side of the second hydraulic source, and
a stroke simulator valve configured to selectively switch a connection between the first simulator fluid passage and the second connection fluid passage, and a connection between the second simulator fluid passage and the intake side of the second hydraulic source.

14. A brake system comprising:
a first hydraulic unit; and
a second hydraulic unit,
wherein the first hydraulic unit includes
a master cylinder unit including a master cylinder,
a first input port connected to a supply port of the master cylinder,
a first connection fluid passage connected to the first input port,
a first hydraulic source configured to discharge brake fluid to the first connection fluid passage, and
a first output port connected to the first connection fluid passage,
wherein the second hydraulic unit includes
a second input port connected to the first output port,
a second connection fluid passage connected to the second input port,
a second hydraulic source configured to discharge the brake fluid to the second connection fluid passage, and
a second output port having one end side connected to the second connection fluid passage and an opposite end side connected to a wheel cylinder,
wherein the hydraulic control apparatus further includes a stroke simulator unit, and
wherein the stroke simulator unit is attached on the second hydraulic unit and includes a stroke simulator configured to generate a reaction force of a brake pedal operation.

15. The brake system according to claim 14, wherein the second hydraulic unit includes
a back-pressure fluid passage connected to a back-pressure chamber of the stroke simulator,
a first simulator fluid passage that connects the back-pressure fluid passage and the second connection fluid passage,
a second simulator fluid passage that connects the back-pressure fluid passage and an intake side of the second hydraulic source, and
a stroke simulator valve configured to selectively switch a connection between the first simulator fluid passage and the second connection fluid passage, and a connection between the second simulator fluid passage and the intake side of the second hydraulic source.

16. The brake system according to claim 14, wherein the stroke simulator unit includes
a simulator connection fluid passage having one end side connected to the stroke simulator, and
a simulator connection port provided on an opposite end side of the simulator connection fluid passage, and
wherein the second hydraulic unit includes
a unit connection port connected to the simulator connection port and overlapping the simulator connection port in an axial direction of the simulator connection port, and
a unit connection fluid passage connected to the unit connection port.

17. The brake system according to claim 16, wherein the stroke simulator includes a piston defining a first chamber and a second chamber in a cylinder,
wherein the simulator connection fluid passage includes
a first simulator connection fluid passage having the one end side connected to the first chamber, and
a second simulator connection fluid passage having the one end side connected to the second chamber.

18. The brake system according to claim 17, wherein the second hydraulic unit includes
a second housing including the second connection fluid passage inside this second hydraulic unit, and
a second motor attached on a second motor attachment surface of the second housing and configured to actuate the second hydraulic source, and
wherein the simulator connection port and the unit connection port overlap each other on a side surface of the second motor attachment surface.

19. The brake system according to claim 18, wherein a direction of an axis along which the stroke simulator is actuated is set to a longitudinal direction of the side surface.

20. The brake system according to claim 14, wherein the second hydraulic unit includes
a second housing including the second connection fluid passage inside this second hydraulic unit, and
a second motor attached on a second motor attachment surface of the second housing and configured to actuate the second hydraulic source, and
wherein a direction of an axis along which the stroke simulator is actuated is set to a longitudinal direction of a side surface of the second motor attachment surface.

21. The brake system according to claim 20, wherein the simulator connection port and the unit connection port overlap each other on the side surface.
